(19) United States
(12) Patent Application Publication
(10) Pub. No.: US 2023/0279213 A1
(43) Pub. Date: Sep. 7, 2023

(54) AQUEOUS COMPOSITION

(71) Applicants: Dow Global Technologies LLC, Midland, MI (US); Rohm and Haas Company, Collegeville, PA (US)

(72) Inventors: Daoshu Lin, Shanghai (CN); Caifeng Wang, Shanghai (CN); Jianming Xu, Shanghai (CN); Yuehan Hu, Shanghai (CN)

(21) Appl. No.: 18/019,295

(22) PCT Filed: Aug. 31, 2020
(86) PCT No.: PCT/CN2020/112471

§ 371 Date: Feb. 2, 2023

(51) Int. Cl. C08L 33/12

(52) U.S. Cl. CPC C08L 33/12

(57) ABSTRACT

An aqueous composition comprising: (a) an aqueous dispersion of hybrid polymer particles with a fluorine content of 5% or more, wherein the hybrid polymer particles comprise, based on the weight of the hybrid polymer particles, (i) greater than 20% to 75% by weight of a first polymer component comprising a fluoroethylene vinyl ether copolymer, and (ii) from 25% to less than 80% by weight of a second polymer component, wherein the second polymer component is an acrylic copolymer comprising, based on the weight of the acrylic copolymer, from 0.15% to 1.2% by weight of structural units of a phosphorus-containing acid monomer, a salt thereof, or mixtures thereof, and structural units of a monoethylenically unsaturated nonionic monomer; and (b) from 5% to 30% by dry weight of colloidal silica, based on the total weight of the hybrid polymer particles and the dry weight of the colloidal silica. The aqueous composition can provide coatings with balanced dirt pick-up resistance and durability properties.

### FIELD OF THE INVENTION

The present invention relates to an aqueous composition comprising an aqueous dispersion of hybrid polymer particles and colloidal silica.

### INTRODUCTION

In exterior coating applications, dirt pick-up resistance (DPUR) and durability are two key properties. DUPR enables coatings to maintain color and gloss upon exposure to the elements such as sunlight. Incorporation of silica sol (also known as “colloidal silica”) is one of approaches to improve DPUR properties in the coating industry, but usually hurts durability. Conventional colloidal silica-containing coatings typically exhibit chalking after exposure to sunlight or under accelerated weathering conditions.

It is therefore desirable to provide an aqueous composition suitable for coating applications that provides exterior coatings, for example, elastomeric wall coatings, with balanced dirt pick-up resistance and durability properties without the aforementioned problems.

### SUMMARY OF THE INVENTION

The present invention provides a novel aqueous composition suitable for exterior coatings. The aqueous composition of the present invention comprises a novel combination of colloidal silica and a specific aqueous dispersion of fluoro-acrylic hybrid polymer particles that can be prepared by polymerization of acrylic monomers in the presence of a fluoroethylene vinyl ether (FEVE) copolymer. The aqueous composition can provide coatings made therefrom without the aforementioned problems.

In a first aspect, the present invention is an aqueous composition comprising:
(a) an aqueous dispersion of hybrid polymer particles with a fluorine content of 5% or more, wherein the hybrid polymer particles comprise, based on the weight of the hybrid polymer particles,
(i) greater than 20% to 75% by weight of a first polymer component comprising a fluoroethylene vinyl ether copolymer, and
(ii) from 25% to less than 80% by weight of a second polymer component, wherein the second polymer component is an acrylic copolymer comprising, based on the weight of the acrylic copolymer, from 0.15% to 1.2% by weight of structural units of a phosphorus-containing acid monomer, a salt thereof, or mixtures thereof; and structural units of a monoethylenically unsaturated nonionic monomer; and
(b) from 5% to 30% by dry weight of colloidal silica, based on the total weight of the hybrid polymer particles and dry weight of the colloidal silica.

In a second aspect, the present invention is a process for preparing the aqueous composition of the first aspect. The process comprises: admixing the aqueous dispersion of hybrid polymer particles with the colloidal silica.

### BRIEF DESCRIPTION OF THE DRAWINGS

FIG. 1 is Scanning Transmission Electron Microscopy (STEM) images of hybrid polymer particles in the aqueous composition of Example 1 at different scales (A) scale bar=1 micron (μm) and (B) scale bar=400 nanometers (nm).

FIG. 2A is a STEM image of pure acrylic copolymer particles in the aqueous composition of Comparative Example 2.

FIG. 2B is a STEM image of pure fluoroethylene vinyl ether copolymer particles in the aqueous composition of Comparative Example 3.

### DETAILED DESCRIPTION OF THE INVENTION

“Aqueous” composition or dispersion herein means that particles dispersed in an aqueous medium. By “aqueous medium” herein is meant water and from 0 to 30%, by weight based on the weight of the medium, of water-miscible compound(s) such as, for example, alcohols, glycols, glycol ethers, glycol esters, or mixtures thereof.

“Structural units”, also known as “polymerized units”, of the named monomer, refers to the remnant of the monomer after polymerization, that is, polymerized monomer or the monomer in polymerized form. For example, a structural unit of methyl methacrylate is as illustrated:

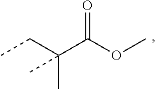

where the dotted lines represent the points of attachment of the structural unit to the polymer backbone.

“Acrylic copolymer” herein refers to a copolymer of an acrylic monomer with a different acrylic monomer or other monomers such as styrene. “Acrylic monomer” as used herein includes (meth)acrylic acid, alkyl (meth)acrylate, (meth)acrylamide, (meth)acrylonitrile and their modified forms such as hydroxyalkyl (meth)acrylate. Throughout this document, the word fragment “(meth)acryl” refers to both “methacryl” and “acryl”. For example, (meth)acrylic acid refers to both methacrylic acid and acrylic acid, and methyl (meth)acrylate refers to both methyl methacrylate and methyl acrylate.

Glass transition temperature or “Tg” as used herein can be measured by various techniques including, for example, differential scanning calorimetry (“DSC”) or calculation by using a Fox equation. The particular values of Tg reported herein are those calculated by using the Fox equation (T. G. Fox, Bull. Am. Physics Soc., Volume 1, Issue No. 3, page 123 (1956)). For example, for calculating the T_{g} of a copolymer of monomers M₁ and M₂,

$$\frac{1}{{T}_{g} ( calc )} = \frac{w ( {M}_{1} )}{{T}_{g} ( {M}_{1} )} + \frac{w ( {M}_{2} )}{{T}_{g} ( {M}_{2} )} ,$$

wherein T_{g}(calc.) is the glass transition temperature calculated for the copolymer, w(M₁) is the weight fraction of monomer M₁ in the copolymer, w(M₂) is the weight fraction of monomer M₂ in the copolymer, T_{g}(M₁) is the glass transition temperature of the homopolymer of monomer M₁, and T_{g}(M₂) is the glass transition temperature of the homopolymer of monomer M₂, all temperatures being in K. The Tgs of the homopolymers may be found, for example, in “Polymer Handbook”, edited by J. Brandrup and E. H. Immergut, Interscience Publishers.

The aqueous composition of the present invention comprises an aqueous dispersion of hybrid polymer particles comprising a first polymer component and a second polymer component. As used herein, the term “polymer component” refers to the polymeric material resulting from a distinct polymerization step. Typically, the hybrid polymer particles comprise two or three polymer components, e.g. a seed component, an imbibe component, and/or a continuous addition component. Different or additional combinations of polymer components may be used, e.g., multiple con-add components may be utilized. The first and second polymer components do not necessarily correspond to an order of addition. That is, the “first polymer component” does not necessarily correspond to the polymer component which is first polymerized, e.g., a seed particle. The terms “first” and “second” are only used to distinguish one component from another, not to designate an order of addition.

The first polymer component in the hybrid polymer particles comprises one or more fluoroethylene vinyl ether copolymer. The fluoroethylene vinyl ether copolymer useful in the present invention can be an alternating copolymer, a random copolymer, or a block copolymer. The fluoroethylene vinyl ether copolymer may be a copolymer of one or more fluoroethylene monomer and one or more vinyl ether monomer, and optionally, one or more ethylenic ally unsaturated carboxylic acid monomer. The fluoroethylene monomer useful in the present invention may comprise chlorotrifluoroethylene, ethylene tetrafluoride, or mixtures thereof. The vinyl ether monomer useful in the present invention may have a formula of CH₂═CH—OR₁, where R₁ is a C₁-C₂₀ alkyl group, a C₁-C₂₀ hydroxyalkyl group, or a C₅-C₂₀ cycloalkyl group. The alkyl group may contain carbon atoms in an amount of 1 or more, 2 or more, 3 or more, or even 4 or more, and at the same time, 20 or less, 16 or less, 12 or less, or even 8 or less. The hydroxyalkyl group may contain carbon atoms in an amount of 1 or more, 2 or more, 3 or more, or even 4 or more, and at the same time, 20 or less, 16 or less, 12 or less, or even 8 or less. The cycloalkyl group may contain carbon atoms in an amount of 5 or more, 6 or more, 7 or more, or even 8 or more, and at the same time, 20 or less, 16 or less, 12 or less, or even 10 or less. Suitable vinyl ether monomers may include, for example, ethyl vinyl ether, isobutyl vinyl ether, butyl vinyl ether, hexyl vinyl ether, cyclohexyl vinyl ether, dodecyl vinyl ether, n-hexadecyl vinyl ether, or mixtures thereof. Suitable ethylenically unsaturated carboxylic acid monomers may include, for example, acrylic acid, methacrylic acid, maleic acid, itaconic acid, crotonic acid, fumaric acid, or mixtures thereof.

Types of the above monomers may be selected to give the fluoroethylene vinyl ether copolymer with a desirable fluoride content and Tgs. The fluoride content of the fluoroethylene vinyl ether copolymer may be 5% or more, 6% or more, 7% or more, or even 8% or more, and at the same time, 40% or less, 35% or less, 30% or less, or even 25% or less, by weight based on the weight of the fluoroethylene vinyl ether copolymer. The fluoroethylene vinyl ether copolymer may have a T_{g} of −20° C. or more, −10° C. or more, 0° C. or more, or even 5° C., and at the same time, 50° C. or less, 40° C. or less, 35° C. or less, or even 30° C. or less, as calculated by the Fox Equation.

The fluoroethylene vinyl ether copolymer useful in the present invention, typically in the form of a dispersion, may be prepared by a free-radical polymerization process such as emulsion polymerization. Polymerization techniques used to prepare the fluoroethylene vinyl ether copolymer are well known in the art, for example, low pressure polymerization. Temperature suitable for the polymerization process may be in the range of from 10 to 100° C., from 30 to 95° C. or less, or from 40 to 90° C. One or more surfactant may be used in the polymerization process. Suitable surfactants may include those described in EP2367858A1, such as hydrocarbon surfactants, siloxane surfactants, fluorosurfactants, or mixtures thereof. The surfactant may be used in an amount of from 0.1% to 5%, from 0.5% to 4%, or from 1% to 3%, by weight based on the total weight of monomers used for preparing the fluoroethylene vinyl ether copolymer. In the polymerization process, free radical initiators may be used. Examples of suitable free radical initiators include persulfate salts such as ammonium persulfate and potassium persulfate, organic peroxide such as hydrogen peroxide, tert-butyl hydrogen peroxide, and tert-amyl hydrogen peroxide; or mixtures thereof. The free radical initiator may be used typically at a level of from 0.05% to 2% or from 0.1% to 1%, by weight based on the total weight of monomers used for preparing the fluoroethylene vinyl ether copolymer. The fluoroethylene vinyl ether copolymer particles in the resultant dispersion may have a particle size of from 50 to 1,000 nm, from 60 to 500 nm, from 80 to 400 nm, or from 100 to 300 nm, as determined by a Brookhaven BI-90 Plus Particle Size Analyzer.

The fluoroethylene vinyl ether copolymer useful in the present invention may have a number average molecular weight in the range of from 1,000 to 500,000 grams per mole (g/mol), from 2,000 to 400,000 g/mol, from 3,000 to 300,000 g/mol, or from 5,000 to 200,000 g/mol, as determined by gel permeation chromatography (GPC) method.

The dispersion of the fluoroethylene vinyl ether copolymer useful in the present invention may have a minimum film formation temperature (MFFT) of from −20 to 50° C., −10 to 40° C., from 0 to 30° C., or from 5 to 25° C. The MFFT can be determined according to the test method described in the Examples section below.

In addition to the fluoroethylene vinyl ether copolymer, the first polymer component may optionally comprise an additional polymer selected from the group consisting of polyvinylidene difluoride (PVDF), a conventional acrylic polymer that is different from the acrylic copolymer in the second polymer component described below, or mixtures thereof. The first polymer component may consist of the fluoroethylene vinyl ether copolymer. The first polymer component may comprise the fluoroethylene vinyl ether copolymer in an amount of 50% or more, 60% or more, 70% or more, 80% or more, 90% or more, 95% or more, 96% or more, 97% or more, 98% or more, 99% or more, or even 100%, by weight based on the weight of total polymers in the first polymer component. The amount of PVDF in the first polymer component may be less than 5%, less than 4%, less than 3%, less than 2%, less than 1%, or even zero, by weight based on the weight of total polymers in the first polymer component.

The hybrid polymer particles useful in the present invention may comprise the first polymer component in an amount of greater than 20%, for example, 21% or more, 22% or more, 23% or more, 24% or more, 25% or more, 26% or more, 27% or more, 28% or more, 29% or more, 30% or more, 32% or more, 35% or more, 38% or more, 40% or more, 42% or more, or even 45% or more, and at the same time, 75% or less, 72% or less, 70% or less, 68% or less, 66% or less, 65% or less, 64% or less, 62% or less, 60% or less, 58% or less, 55% or less, 52% or less, or even 50% or less, by weight based on the weight of the hybrid polymer particles.

The fluorine content of the hybrid polymer particles in the present invention may be 5% or more, 5.1% or more, 5.2% or more, 5.3% or more, 5.4% or more, 5.5% or more, 5.6% or more, 5.7% or more, 5.8% or more, 5.9% or more, or even 6% or more, at the same time is typically 35% or less, 32% or less, 30% or less, 28% or less, 25% or less, 22% or less, 20% or less, 18% or less, 16% or less, 15% or less, 14% or less, or even 12% or less, by weight based on the weight of hybrid polymer particles. The fluorine content may be determined according to the description in Progress in Organic Coatings, Volume 53, Issue 3, pages 207-211 (2005).

The hybrid polymer particles useful in the present invention further comprise one or more acrylic copolymer as the second polymer component. Acrylic copolymers useful in the present invention comprise structural units of one or more phosphorus-containing acid monomer, a salt thereof, or mixtures thereof. Suitable phosphorous-containing acid monomers and salts thereof may include phosphoalkyl (meth)acrylates such as phosphoethyl (meth)acrylate, phosphopropyl (meth)acrylate, phosphobutyl (meth)acrylate, salts thereof, and mixtures thereof; CH₂=C(R₁)—C(O)—O—(R₂O)_{q}—P(O)(OH)₂, wherein R₁=H or CH₃, R₂=alkylene, such as an ethylene group, a propylene group, a butylene group, or a combination thereof; and q=1-20, such as SIPOMER PAM-100, SIPOMER PAM-200, SIPOMER PAM-300, SIPOMER PAM-600 and SIPOMER PAM-4000 all available from Solvay; phosphoalkoxy (meth)acrylates such as phospho ethylene glycol (meth)acrylate, phospho di-ethylene glycol (meth)acrylate, phospho tri-ethylene glycol (meth)acrylate, phospho propylene glycol (meth)acrylate, phospho dipropylene glycol (meth)acrylate, phospho tri-propylene glycol (meth)acrylate, salts thereof, and mixtures thereof. Preferred phosphorus-containing acid monomers and salts thereof are selected from the group consisting of phosphoethyl (meth)acrylate, phosphopropyl (meth)acrylate, phosphobutyl (meth)acrylate, allyl ether phosphate, salts thereof, or mixtures thereof; more preferably, phosphoethyl methacrylate (PEM). The acrylic copolymer may comprise structural units of the phosphorus-containing acid monomer, the salt thereof, and mixtures thereof, in an amount of 0.15% or more, 0.16% or more, 0.17% or more, 0.18% or more, 0.19% or more, 0.2% or more, 0.21% or more, 0.22% or more, 0.23% or more, 0.24% or more, 0.25% or more, 0.26% or more, 0.27% or more, 0.28% or more, 0.29% or more, or even 0.3% or more, and at the same time, 1.2% or less, 1.15% or less, 1.1% or less, 1.05% or less, 1% or less, 0.98% or less, 0.95% or less, 0.92% or less, 0.9% or less, 0.88% or less, 0.85% or less, 0.8% or less, 0.75% or less, 0.7% or less, 0.65% or less, 0.6% or less, 0.55% or less, or even 0.5% or less, by weight based on the weight of the acrylic copolymer.

The acrylic copolymer useful in the present invention may further comprise structural units of one or more additional monoethylenically unsaturated ionic monomer that is different from the phosphorus-containing acid monomer and the salts thereof above. The term “ionic monomer” herein refers to a monomer that bears an ionic charge between pH=1-14. The monoethylenically unsaturated ionic monomers may include carboxylic acid monomers, sulfonic acid monomers, sulfate monomers; salts thereof; or mixtures thereof. The carboxylic acid monomers can be α, β-ethylenically unsaturated carboxylic acids, monomers bearing an acid-forming group which yields or is subsequently convertible to, such an acid group (such as anhydride, (meth)acrylic anhydride, or maleic anhydride); or mixtures thereof. Specific examples of carboxylic acid monomers include acrylic acid, methacrylic acid, maleic acid, itaconic acid, crotonic acid, fumaric acid, or mixtures thereof. The sulfonic acid monomers and salts thereof may include sodium vinyl sulfonate (SVS), sodium styrene sulfonate (SSS), acrylamido-methyl-propane sulfonate (AMPS), or mixtures thereof. The acrylic copolymer may comprise structural units of the additional monoethylenically unsaturated ionic monomer in an amount of zero or more, 0.05% or more, 0.1% or more, 0.3% or more, 0.5% or more, or even 1% or more, and at the same time, 5% or less, 4.5% or less, 4% or less, 3.5% or less, 3% or less, or even 2% or less, by weight based on the weight of the acrylic copolymer.

The acrylic copolymer useful in the present invention may comprise structural units of one or more monoethylenically unsaturated nonionic monomer. The term “nonionic monomer” herein refers to a monomer that does not bear an ionic charge between pH=1-14. Monoethylenically unsaturated nonionic monomers may include C₁-C₂₀, C₁-C₁₀, or C₁-C₈-alkyl esters of (meth)acrylic acid. Examples of suitable monoethylenically unsaturated nonionic monomers include methyl acrylate, methyl methacrylate, ethyl acrylate, butyl acrylate, 2-ethylhexyl acrylate, decyl acrylate, lauryl acrylate, methyl methacrylate, butyl methacrylate, isodecyl methacrylate, lauryl methacrylate, hydroxyethyl methacrylate, hydroxypropyl methacrylate, or combinations thereof; (meth)acrylamide; (meth)acrylonitrile; ureido-functional monomers such as hydroxyethyl ethylene urea methacrylate; cycloalkyl (meth)acrylates such as cyclohexyl (meth)acrylate, methcyclohexyl acrylate, isobornyl (meth)acrylate, and dihydrodicyclopentadienyl acrylate; monomers bearing acetoacetate-functional groups such as acetoacetoxyethyl methacrylate (AAEM); monomers bearing carbonyl-containing groups such as diacetone acrylamide (DAAM); vinyl aromatic monomers including styrene and substituted styrene such as .alpha.-methyl styrene, p-methyl styrene, t-butyl styrene, vinyltoluene, or mixtures thereof; vinyltrialkoxysilanes such as vinyltrimethoxysilane, vinyltriethoxysilane, and vinyltris(2-methoxyethoxy)silane, vinyldimethylethoxysilane, vinylmethyldiethoxysilane, and (meth)acryloxyalkyltrialkoxysilanes such as (meth)acryloxyethyltrimethoxysilane and (meth)acryloxypropyltrimethoxysilane; α-olefins such as ethylene, propylene, and 1-decene; vinyl acetate, vinyl butyrate, vinyl versatate and other vinyl esters; glycidyl (meth)acrylate; or combinations thereof. Preferred monoethylenically unsaturated nonionic monomers are selected from the group consisting of methyl methacrylate, ethyl acrylate, butyl acrylate, styrene, or mixtures thereof. The acrylic copolymer may comprise structural units of the monoethylenically unsaturated nonionic monomer in an amount of 50% or more, 55% or more, 60% or more, 65% or more, 70% or more, 75% or more, or even 80% or more, and at the same time, 99% or less, 98% or less, 97% or less, 95% or less, 90% or less, or even 85% or less, by weight based on the weight of the acrylic copolymer.

The acrylic copolymer useful in the present invention may optionally comprise structural units of one or more multiethylenically unsaturated monomer including di-, tri-, tetra-, or higher multifunctional ethylenically unsaturated monomers. Suitable multiethylenically unsaturated monomers may include, for example, allyl (meth)acrylate, diallyl phthalate, divinyl benzene, ethylene glycol dimethacrylate, butylene glycol dimethacrylate, or mixtures thereof. The acrylic copolymer may comprise structural units of the multiethylenically unsaturated monomer in an amount of zero or more, 0.05% or more, or even 0.1% or more, and at the same time, 5% or less, 3% or less, 1% or less, or even 0.5% or less, by weight based on the weight of the acrylic copolymer.

Types and levels of the monomers described above may be chosen to provide the acrylic copolymer with Tgs suitable for different applications, for example, −20° C. or more, −15° C. or more, −10° C. or more, −5° C. or more, or even 0° C. or more, and at the same time, 50° C. or less, 45° C. or less, 40° C. or less, 35° C. or less, or even 30° C. or less, as calculated by the Fox Equation.

The second polymer component in the hybrid polymer particles may consist of the acrylic copolymer. The hybrid polymer particles may comprise the second polymer component in an amount of 25% or more, 28% or more, 30% or more, 32% or more, 34% or more, 35% or more, 36% or more, 38% or more, 40% or more, 42% or more, 45% or more, 48% or more, or even 50% or more, and at the same time, less than 80%, 75% or less, 74% or less, 73% or less, 72% or less, 71% or less, 70% or less, 68% or less, 65% or less, 62% or less, 60% or less, 58% or less, or even 55% or less, by weight based on the total weight of the hybrid polymer particles.

Preferred hybrid polymer particles comprise, by weight based on the weight of the hybrid polymer particles, from 30% to 70% of the fluoroethylene vinyl ether copolymer and from 70% to 30% of the acrylic copolymer, wherein the acrylic copolymer with a T_{g} in the range of from 0 to 30° C. comprises, by weight based on the weight of the acrylic copolymer, from 0.2% to 0.5% of structural units of the phosphorous-containing acid monomer, salt thereof, or mixtures thereof.

The hybrid polymer particles useful in the present invention may comprise an interpenetrating polymer network (IPN) of the first polymer component and the second polymer component. The term “interpenetrating polymer network” herein refers to a material containing at least two polymer components, each in network form wherein at least one of the polymers is synthesized and/or crosslinked in the presence of the other. The polymer networks are physically entangled with each other and in some embodiments may be also be covalently bonded. IPNs have also been described in: C. H. Sperling, “Interpenetrating Polymer Networks and Related Materials”, Plenum Press, N Y, (1981); and in “Sulfonic Acid Resins with Interpenetrating Polymer Networks,” D. Klempner and K. C. Rrisch, ed., Advances in Interpenetrating Polymer Networks, Volume II, Technomic Publishing Co. Inc., pg. 157-176, Lancaster, Basel (1990). The hybrid polymer particles may have a “core-shell” structure, an “acorn” structure, a “strawberry structure”, or a “multi-loop” structure. Hybrid polymer particles comprising the interpenetrating polymer network may be characterized by STEM.

The aqueous dispersion of hybrid polymer particles may be prepared by free-radical polymerization such as emulsion polymerization of an acrylic monomer mixture in the presence of the first polymer component comprising the fluoroethylene vinyl ether copolymer. Polymerization of the acrylic monomer mixture forms the acrylic copolymer. The acrylic monomer mixture comprises monomers described above that are used for forming structural units the acrylic copolymer, including the phosphorus-containing acid monomer, salt thereof, or mixtures thereof, for example, in an amount of from 0.15% to 1% by weight of the acrylic monomer mixture; and the monoethylenically unsaturated nonionic monomer. For each monomer, the concentration of the monomer based on the total weight of the acrylic monomer mixture is the same as the concentration of structural units of such monomer based on the weight of the acrylic copolymer. The fluoroethylene vinyl ether copolymer in the first polymer component can be swollen with the acrylic monomer mixture that is subsequently polymerized. The acrylic monomer mixture may be added to the fluoroethylene vinyl ether copolymer in one addition. Alternatively, the hybrid polymer particles may be formed via a seeded process wherein a seed polymer (e.g., fluoroethylene vinyl ether copolymer) is first formed and subsequently imbibed with a portion of the acrylic monomer mixture (e.g., 30%-50% by weight of the acrylic monomer mixture), that is subsequently polymerized. Additional monomers such as the rest of the acrylic monomer mixture may be subsequently added during the polymerization process (i.e., “continuous addition” or “con-add”). The fluoroethylene vinyl ether copolymer may be formed in a different reactor. The formation of the seed polymer constitutes a distinct polymer component, that is the first polymer component. Similarly, the process step of imbibing and polymerizing the acrylic monomer mixture into the seed constitutes yet another polymer component, for example, the second polymer component. If used, the subsequent continuous addition of the additional monomers commonly used to “grow up” the seed also constitutes a distinct polymer component, for example, the third polymer component. Except as specifically described herein, the constituents of the second and the third polymer components may be the same or different. Moreover, the acrylic monomer mixture used during a polymerization step need not be homogeneous; that is, the ratio and type of monomers may be varied. Preferably, the acrylic monomer mixture for imbibing the first polymer component such as the fluoroethylene vinyl ether copolymer has the same monomer composition as the additional monomer subsequent added. Polymerization techniques used to polymerize the acrylic monomer mixture are well known in the art. The acrylic monomer mixture may be added neat or as an emulsion in water; or added in one or more addition or continuously, linearly or nonlinearly, over the reaction period of preparing the acrylic copolymer. Total weight concentration of monomers in the acrylic monomer mixture is equal to 100%. Temperature suitable for polymerization of the acrylic monomer mixture may be lower than 100° C., in the range of from 30 to 98° C., or in the range of from 50 to 95° C.

One or more surfactant may be used in the polymerization process for preparing the aqueous dispersion of hybrid polymer particles. The surfactant may be added prior to or during the polymerization of the acrylic monomer mixture, or combinations thereof. A portion of the surfactant can also be added after the polymerization. These surfactants may include anionic and/or nonionic surfactants. Examples of suitable surfactants include alkali metal or ammonium salts of alkyl, aryl, or alkylaryl sulfates, sulfonates or phosphates; alkyl sulfonic acids; sulfosuccinate salts; fatty acids; ethylenically unsaturated surfactant monomers; and ethoxylated alcohols or phenols. The surfactant is usually used in an amount of from 0.1% to 5%, from 0.15% to 4%, from 0.2% to 3%, or from 0.2% to 2%, by weight based on the total weight of the acrylic monomer mixture.

In the polymerization process for preparing the aqueous dispersion of hybrid polymer particles, one or more chain transfer agent may be used in the polymerization of the acrylic monomer mixture. Examples of suitable chain transfer agents include n-dodecylmercaptan (nDDM), and 3-mercaptopropionic acid, methyl 3-mercaptopropionate (MMP), butyl 3-mercaptopropionate (BMP), benzenethiol, azelaic alkyl mercaptan, or mixtures thereof. The chain transfer agent may be used in an effective amount to control the molecular weight of the acrylic copolymer, for example, in an amount of 0.01% or more, 0.05% or more, or even 0.1% or more, and at the same time, 2% or less, 1% or less, or even 0.5% or less, by weight based on the total weight of the acrylic monomer mixture.

In the polymerization process for preparing the aqueous dispersion of hybrid polymer particles, free radical initiators may be used in the polymerization of the acrylic monomer mixture. The polymerization process may be thermally initiated or redox initiated emulsion polymerization. Examples of suitable free radical initiators include hydrogen peroxide, t-butyl hydroperoxide, cumene hydroperoxide, ammonium and/or alkali metal persulfates, sodium perborate, perphosphoric acid, and salts thereof; potassium permanganate, and ammonium or alkali metal salts of peroxydisulfuric acid. The free radical initiators may be used typically at a level of from 0.1% to 5% or from 0.3% to 3%, by weight based on the total weight of the acrylic monomer mixture. Redox systems comprising the above described initiators coupled with a suitable reductant may be used in the polymerization process. Examples of suitable reductants include sodium sulfoxylate formaldehyde, ascorbic acid, isoascorbic acid, alkali metal and ammonium salts of sulfur-containing acids, such as sodium sulfite, bisulfite, thiosulfate, hydrosulfite, sulfide, hydrosulfide or dithionite, formadinesulfinic acid, acetone bisulfite, glycolic acid, hydroxymethanesulfonic acid, glyoxylic acid hydrate, lactic acid, glyceric acid, malic acid, tartaric acid and salts of the preceding acids. Metal salts of iron, copper, manganese, silver, platinum, vanadium, nickel, chromium, palladium, or cobalt may be used to catalyze the redox reaction. Chelating agents for the metals may optionally be used.

After completing the polymerization for preparing the aqueous dispersion of hybrid polymer particles, the obtained dispersion of hybrid polymer particles may be neutralized by one or more base as a neutralizer to a pH value, for example, at least 6, from 6 to 10, or from 7 to 9. The bases may lead to partial or complete neutralization of the ionic or latently ionic groups of the hybrid particles. Examples of suitable bases include ammonia; alkali metal or alkaline earth metal compounds such as sodium hydroxide, potassium hydroxide, calcium hydroxide, zinc oxide, magnesium oxide, sodium carbonate; primary, secondary, and tertiary amines, such as triethyl amine, ethylamine, propylamine, monoisopropylamine, monobutylamine, hexylamine, ethanolamine, diethyl amine, dimethyl amine, tributylamine, triethanolamine, dimethoxyethylamine, 2-ethoxyethylamine, 3-ethoxypropylamine, dimethylethanolamine, diisopropanolamine, morpholine, ethylenediamine, 2-diethylaminoethylamine, 2,3-diaminopropane, 1,2-propylenediamine, neopentanediamine, dimethylaminopropylamine, hexamethylenediamine, 4,9-dioxadodecane-1,12-diamine, polyethyleneimine or polyvinylamine; aluminum hydroxide; or mixtures thereof. The hybrid polymer particles in the aqueous dispersion may have a particle size of from 50 to 500 nm, from 60 to 400 nm, from 90 to 300 nm, from 95 to 250 nm, or from 100 to 200 nm. The particle size herein refers to Z-average size and may be measured by a Brookhaven BI-90 Plus Particle Size Analyzer.

In addition to the aqueous dispersion of hybrid polymer particles, the aqueous composition of the present invention further comprises colloidal silica (also known as “silica sol”). The colloidal silica herein refers to a dispersion of amorphous silicon dioxide (SiO₂) particles, which are typically dispersed in water, suitably in the presence of stabilizing cations such as K+, Na⁺, Li⁺, NH₄⁺, organic cations, primary, secondary, tertiary, and quaternary amines, and mixtures thereof. The colloidal silica is typically anionic colloidal silica. The surface of the anionic colloidal silica is composed mostly of hydroxyl groups with the formula of Si—O—H. Other groups may also exist including, for example, silanediol (—Si—(OH)₂), silanetriol (—Si(OH)₃), surface siloxanes (—Si—O—Si—O—), and surface-bound water. The anionic colloidal silica usually has a pH value >7.5, >8, >8.5, or even 9 or more, and at the same time, 11.5 or less or 11 or less.

The colloidal silica useful in the present invention may be derived from, for example, precipitated silica, fumed silica, pyrogenic silica or silica gels, or mixtures thereof. Silica particles in the colloidal silica may be modified and can contain other elements such as amines, aluminum and/or boron. Boron-modified colloidal silica particles may include those described in, for example, U.S. Pat. No. 2,630,410. Aluminum-modified colloidal silica may have an aluminum oxide (Al₂O₃) content of from 0.05% to 3% by weight, and preferably from 0.1% to 2% by weight, based on total dry weight of the colloidal silica. Preparation of the aluminum-modified colloidal silica is further described in, for example, “The Chemistry of Silica”, by Iler, K. Ralph, pages 407-409, John Wiley & Sons (1979) and in U.S. Pat. No. 5,368,833. Silica content of the colloidal silica may be present, by weight based on the weight of the anionic colloidal silica, from 10% to 80%, from 12% to 70%, or from 15% to 60%. Silica particles in the colloidal silica may have an average particle size ranging from 5 nm to 100 nm, from 6 nm to 80 nm, from 7 nm to 50 nm, or from 8 nm to 40 nm. The silica particles in the colloidal silica may have a specific surface area of from 20 to 800 square meters per gram (m²/g), from 30 to 750 m²/g or from 50 to 700 m²/g. The particle size and specific surface area of the silica particles may be measured by the methods described in the Examples section below.

The colloidal silica may be present in the aqueous composition of the present invention, by dry weight based on the total weight of the hybrid polymer particles and dry weight of the colloidal silica, in an amount of 5% or more, 5.2% or more, 5.5% or more, 5.8% or more, 6% or more, 6.2% or more, 6.5% or more, 6.8% or more, 7% or more, 7.5% or more, 8% or more, 8.5% or more, 9% or more, 9.5% or more, or even 10% or more, and at the same time, 30% or less, 28% or less, 25% or less, 22% or less, 20% or less, 18% or less, or even 15% or less. Percentage herein is obtained by:

[Dry Weight_{(colloidal silica)}/(Weight_{(hybrid polymer particles)}+Dry Weight_{(colloidal silica)}]×100%,

where Dry Weight_{(colloidal silica)}=Weight_{(colloidal silica)}×Solids Content_{(colloidal silica)}.

The aqueous composition of the present invention further comprises water. The concentration of water may be, by weight based on the total weight of the composition, from 30% to 90% or from 40% to 80%.

The aqueous composition of the present invention may be useful as binders in many applications including wood coatings, architecture coatings, metal coatings, and traffic paints. The aqueous composition of the present invention can be an aqueous coating composition. For coating applications, the aqueous composition may comprise the aqueous dispersion of hybrid polymer particles and the colloidal silica in a combined amount of 10% or more, 15% or more, 20% or more, or even 25% or more, and at the same time 60% or less, 55% or less, 50% or less, or even 45% or less, by weight based on the total weight of the aqueous composition.

The aqueous composition of the present invention may further comprise one or more pigment. “Pigment” herein refers to a particulate inorganic material which is capable of materially contributing to the opacity or hiding capability of a coating. Such materials typically have a refractive index greater than 1.8. Inorganic pigments may include, for example, titanium dioxide (TiO₂), zinc oxide, iron oxide, zinc sulfide, barium sulfate, barium carbonate, or mixture thereof. In a preferred embodiment, pigment used in the present invention is TiO₂. TiO₂ typically exists in two crystal forms, anastase and rutile. TiO₂ may be also available in concentrated dispersion form. The aqueous coating composition may also comprise one or more extender. The term “extender” herein refers to a particulate inorganic material having a refractive index of less than or equal to 1.8 and greater than 1.3. Examples of suitable extenders include calcium carbonate, clay, calcium sulfate, aluminosilicates, silicates, zeolites, mica, diatomaceous earth, solid or hollow glass, ceramic beads, nepheline syenite, feldspar, diatomaceous earth, calcined diatomaceous earth, talc (hydrated magnesium silicate), silica, alumina, kaolin, pyrophyllite, perlite, baryte, wollastonite, opaque polymers such as ROPAQUE™ Ultra E available from The Dow Chemical Company (ROPAQUE is a trademark of The Dow Chemical Company), or mixtures thereof. The aqueous coating composition may have a pigment volume concentration (PVC) of 8% or more, 10% or more, 20% or more, 30% or more, and at the same time, 50% or less, 45% or less, or even 40% or less. PVC may be determined by the equation: PVC=[Volume_{(Pigment+Extender)}/Volume_{(Pigment+Extender+Hybrid polymer particles+Colloidal silica)}]×100%.

The aqueous composition of the present invention may comprise one or more defoamer. The term “defoamer” herein refer to a chemical additive that reduces and hinders the formation of foam. Defoamers may be silicone-based defoamers, mineral oil-based defoamers, ethylene oxide/propylene oxide-based defoamers, alkyl polyacrylates, or mixtures thereof. Suitable commercially available defoamers include, for example, TEGO Airex 902 W and TEGO Foamex 1488 polyether siloxane copolymer emulsions both available from TEGO, BYK-024 silicone deformer available from BYK, or mixtures thereof. The defoamer may be present in an amount of from zero to 2%, from 0.1% to 1.5%, or from 0.2% to 1%, by weight based on the total dry weight of the aqueous composition.

The aqueous composition of the present invention may comprise one or more thickener. Thickeners may include polyvinyl alcohol (PVA), clay materials, acid derivatives, acid copolymers, urethane associate thickeners (UAT), polyether urea polyurethanes (PEUPU), polyether polyurethanes (PEPU), or mixtures thereof. Examples of suitable thickeners include alkali swellable emulsions (ASE) such as sodium or ammonium neutralized acrylic acid polymers; hydrophobically modified alkali swellable emulsions (HASE) such as hydrophobically modified acrylic acid copolymers; associative thickeners such as hydrophobically modified ethoxylated urethanes (HEUR); and cellulosic thickeners such as methyl cellulose ethers, hydroxymethyl cellulose (HMC), hydroxyethyl cellulose (HEC), hydrophobically-modified hydroxy ethyl cellulose (HMHEC), sodium carboxymethyl cellulose (SCMC), sodium carboxymethyl 2-hydroxyethyl cellulose, 2-hydroxypropyl methyl cellulose, 2-hydroxyethyl methyl cellulose, 2-hydroxybutyl methyl cellulose, 2-hydroxyethyl ethyl cellulose, and 2-hydoxypropyl cellulose. Preferably, the thickener is a hydrophobically-modified hydroxy ethyl cellulose (HMHEC). The thickener may be present in an amount of from zero to 4%, from 0.2% to 3%, or from 0.4% to 2%, by dry weight based on the total dry weight of the aqueous composition.

The aqueous composition of the present invention may comprise one or more wetting agent. The term “wetting agent” herein refers to a chemical additive that reduces the surface tension of a coating composition, causing the coating composition to more easily spread across or penetrate the surface of a substrate. Wetting agents may be polycarboxylates, anionic, zwitterionic, or non-ionic. The wetting agent may be present in an amount of from zero to 3%, from 0.1% to 2.5%, or from 0.2% to 2%, by weight based on the total dry weight of the aqueous composition.

The aqueous composition of the present invention may comprise one or more dispersant. Dispersants may include nonionic, anionic, or cationic dispersants such as polyacids with suitable molecular weight, 2-amino-2-methyl-1-propanol (AMP), dimethyl amino ethanol (DMAE), potassium tripolyphosphate (KTPP), trisodium polyphosphate (TSPP), citric acid and other carboxylic acids. The polyacids used may include homopolymers and copolymers based on polycarboxylic acids (e.g., weight average molecular weight ranging from 1,000 to less than 50,000 as measured by GPC), including those that have been hydrophobically- or hydrophilically-modified, e.g., polyacrylic acid or polymethacrylic acid or maleic anhydride with various monomers such as styrene, acrylate or methacrylate esters, diisobutylene, and other hydrophilic or hydrophobic comonomers; salts of thereof; or mixtures thereof. The dispersant may be present in an amount of from zero to 3%, from 0.1% to 2%, from 0.2% to 1.5%, or from 0.3% to 1.2%, by dry weight based on the total dry weight of the aqueous composition. The aqueous composition of the present invention may comprise one or more coalescent.

The term “coalescent” herein refers to a slow-evaporating solvent that fuses polymer particles into a continuous film under ambient condition. Examples of suitable coalescents include 2-n-butoxyethanol, dipropylene glycol n-butyl ether, propylene glycol n-butyl ether, dipropylene glycol methyl ether, propylene glycol methyl ether, propylene glycol n-propyl ether, diethylene glycol monobutyl ether, ethylene glycol monobutyl ether, ethylene glycol monohexyl ether, triethylene glycol monobutyl ether, dipropylene glycol n-propyl ether, n-butyl ether, or mixtures thereof. Preferred coalescents include dipropylene glycol n-butyl ether, ethylene glycol monobutyl ether, diethylene glycol monobutyl ether, n-butyl ether, or mixtures thereof. The coalescent may be present in an amount of from zero to 30%, from 0.1% to 20%, or from 0.5% to 15%, by weight based on the total dry weight of the aqueous composition.

In addition to the components described above, the aqueous coating composition of the present invention may further comprise any one or combination of the following additives: buffers, neutralizers, photo crosslinkers, anti-freezing agents, humectants, mildewcides, biocides, anti-skinning agents, colorants, flowing agents, anti-oxidants, plasticizers, leveling agents, thixotropic agents, adhesion promoters, and grind vehicles. These additives may be present in a combined amount of from zero to 5%, from 0.1% to 4%, or from 0.5% to 3%, by weight based on the dry weight of the aqueous composition.

The aqueous composition of the present invention may be prepared by admixing the aqueous dispersion of hybrid particles and the colloidal silica with other optional components described above. Components in the aqueous composition may be mixed in any order to provide the composition of the present invention. Any of the above-mentioned optional components may also be added to the composition during or prior to the mixing to form the aqueous composition. When the aqueous composition is an aqueous coating composition, such composition may comprise the pigment and/or extender.

The present invention also relates to a process for using the aqueous composition of the present invention for coating applications. The process may comprise: applying the aqueous composition to a substrate, and drying, or allowing to dry, the applied aqueous composition. The present invention also relates to a method of producing a coating on a substrate, comprising: applying the substrate the aqueous composition of the present invention, and drying, or allowing to dry the aqueous composition to form the coating with balanced properties of improved dirt pick-up resistance (DPUR) and good durability. “Improved DPUR” refers to a coating showing ΔY of 10 or less after accelerated dirt pick-up resistance test. “Good durability” refers to ΔE value being 6.0 or less after the accelerated weathering test for 720 hours. DPUR and durability properties may be measured according to the test methods described in the Examples section below.

The aqueous composition of the present invention can be applied to, and adhered to, various substrates. Examples of suitable substrates include wood, metals, plastics, foams, stones, elastomeric substrates, glass, fabrics, concrete, or cementitious substrates. The coating composition, preferably comprising the pigment, is suitable for various applications such as marine and protective coatings, automotive coatings, traffic paint, Exterior Insulation and Finish Systems (EIFS), roof mastic, wood coatings, coil coatings, plastic coatings, powder coatings, can coatings, architectural coatings, and civil engineering coatings. The coating composition is particularly suitable for architectural coatings.

The aqueous composition of the present invention can be applied to a substrate by incumbent means including brushing, dipping, rolling and spraying, preferably by spraying. The standard spray techniques and equipment for spraying such as air-atomized spray, air spray, airless spray, high volume low pressure spray, and electrostatic spray such as electrostatic bell application, and either manual or automatic methods can be used. After the aqueous composition has been applied to a substrate, the aqueous composition can dry, or allow to dry, to form a film (this is, coating) at room temperature (20-25° C.), or at an elevated temperature, for example, from 35° C. to 80° C. The resultant coated substrate has improved DPUR and good durability.

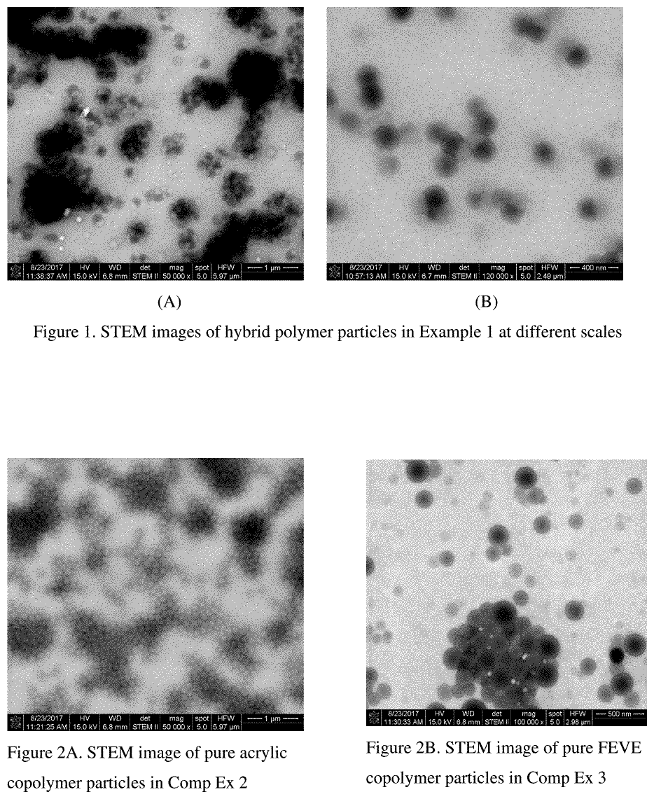

FIG. 1 shows the STEM images of hybrid polymer particles in the aqueous dispersion of Example 1 at different scales, as determined by the STEM method described in Microscopy and Microanalysis, Volume 19, Issue 2, pages 319-326 (2013). In FIG. 1, the light part in the images represents the acrylic copolymer and the dyeing part represents the FEVE copolymer. FIGS. 2A and 2B show the STEM images of pure acrylic copolymer particles in Comparative Example 2 and pure fluoroethylene vinyl ether copolymer particles in Comparative Example 3, respectively. The STEM images in FIG. 1 show an IPN structure with an “acorn” morphology.

### Examples

Some embodiments of the invention will now be described in the following Examples, wherein all parts and percentages are by weight unless otherwise specified.

Eterflon 4302 water-based fluoropolymer resin dispersion (“FEVE 4302”), available from Eternal Chemical Company, comprises fluoroethylene vinyl ether (FEVE) copolymer particles with an average particle size of 200 nm as measured by a Brookhaven BI-90 Plus Particle Size Analyzer (fluorine content: >23%, solids content: 49%, and MFFT: 20° C.).

Butyl acrylate (BA) and methyl methacrylate (MMA) are available from Langyuan Chemical Co., Ltd.

Methacrylic acid (MAA), isoascorbic acid (IAA), tert-butyl hydroperoxide (t-BHP), and ammonium persulfate (APS) are available from Sinopharm Chemical Reagent Co., Ltd.

Phosphate ethyl methacrylate (PEM) is available from Solvay.

DISPONIL A-19 sodium dodecyl (Linear) benzene sulfonate is available from BASF.

Aerosol A-102 ethoxylated alkyl succinate surfactant is available from Solvay Group.

Bruggolite FF6M (FF-6) used as a reducing agent is available from Brueggemann Chemical.

AMP-95 neutralizer is available from ANGUS Chemical Company.

Bindzil EN-130 silica sol, available from Nouryon Company, is an aqueous dispersion comprising anionic silica particles with an average particle size of 20 nm (solids content: 40%).

Natrosol 250HBR thickener, available from Ashland Specialty Chemical, is hydroxyethylcellulose surface-treated with glyoxal.

Tego Foamex 825 defoamer is available from Evonik Chemical Company

Ti-Pure R-902 titanium dioxide pigment is available from Chemour Company.

Minex 4 extender is available from Sibelco Company.

CC-700 extender is available from Guangfu Building Material Group.

ROCIMA 363 biocide is available from DuPont Company.

ROPAQUE™ Ultra E opaque polymer is available from The Dow Chemical Company.

Texanol coalescent is available from Eastman Chemical Company.

OROTAN™ 731A dispersant, TRITON™ CF-10 wetting agent, and TRITON DF-16 defoamer are all available from The Dow Chemical Company.

ACRYSOL™ RM-2020 NPR and ACRYSOL RM-8W rheology modifiers, available from The Dow Chemical Company, are hydrophobically modified urethanes.

OROTAN, TRITON and ACRYSOL are all trademarks of The Dow Chemical Company.

The following standard analytical equipment and methods are used in the Examples and in determining the properties and characteristics stated herein:

### Average Particle Size and Specific Surface Area of Colloidal Silica

Average particle size and specific surface area of colloidal silica were determined according to China Industry Standard HG/T 2521-2008 (Silica sol for industrial use). One and half (1.50) grams (g) of colloidal silica were mixed with deionized (DI) water (100 g) in a beaker. The pH value of the resulting dispersion was adjusted to 3˜3.5 with HCl or NaOH solutions. NaCl (30 g) was further added into the obtained dispersion, followed by adding DI water to adjust the dispersion volume to 150 ml and to fully dissolve NaCl. The obtained dispersion was then titrated using a standard NaOH solution (0.1 mol/L). The accurate concentration of the standard NaOH used in the test was recorded and denoted as “c”. The volume of NaOH standard solution used for pH shifting from 4.00˜9.00 is recoded and denoted as “V”. The average particle size in nanometer, denoted as “D”, is determined by: D=2727/(320Vc−25). The specific surface area of colloidal silica, denoted as “SA”, is determined by: SA=320Vc-25.

### MFFT Measurement

MFFT was measured using a Coesfeld MFFT instrument by casting a 75 μm wet film of an aqueous dispersion sample on a heating plate with gradient temperature. The film was dried and the minimum temperature at which a coherent film formed is recorded as the MFFT.

### Accelerated Dirt Pick-Up Resistance (DPUR) Test

The DUPR test was conducted according to the following steps:
(1) a test coating composition sample was applied onto a cement panel using a wire stick applicator (120 μm);
(2) the obtained panel was allowed to dry in in a constant temperature room (CTR) (23° C. and 50% relative humidity (RH)) for 4 hours;
(3) then a second coat of the test coating composition was applied onto the panel obtained from step (2) by using a wire stick applicator (80 μm);
(4) the obtained coated panel was allowed to dry in the CTR for 1 week;
(5) the reflect coefficient of the panel was then measured at least in three places, and then the mean value was calculated, denoted as Y₀*;
(6) coal ash and water were mixed at a weight ratio of 1:1 to form a slurry;
(7) the slurry (0.7±0.1 g) was then brushed uniformly onto the coated panel using a brush;
(8) the panel was then allowed to dry in an oven at 60° C. oven for 30 minutes (min), and then cooled to room temperature for 2 hours;
(9) the panel was washed by water in maximum flow evenly for 1 min;
(10) the rinsed panel was allowed to dry in the CTR overnight;
(11) step 6 to step 10 constituted one cycle and repeated for another 3 times;
(12) after 4 cycles, the reflect coefficient of the panel was measured at least in three places, and the mean value was calculated and denoted as Y_{F}*. The reflection Y change ratio, denoted as ΔY, was calculated according to the equation:

ΔY=(Y₀*−Y_{F}*)/Y₀*×100

Y₀* and Y_{F}* values were measured by a Spectro-guide Sphere Gloss Portable Spectrophotometers (BYK-Gardner). ΔY value being 10 or less indicates acceptable DPUR property. The smaller ΔY value, the better DPUR property.

### Accelerated Weathering Test (QUV) for Durability

A test coating composition was applied onto aluminum panels using an applicator with a wet film thickness of 150 μm. All sample panels were dried for one week in the CTR (temperature: 23±2° C., Humidity: (45˜65%)±10%), and then were cut to exactly 3 cm*9 cm to fit QUV racks. Each test panel was identified on the reverse side using a black marker, and initial L₀*, a₀*, and b₀* values of each panel were obtained by a Spectro-guide Sphere Gloss Portable Spectrophotometers (BYK company). Meanwhile, the starting time was recorded. The test panels were put into the QUV equipment (QUV/Se QUV Accelerated Weathering Tester from Q-Lab Corporation, 340 nm light source UVA, and 0.77 w/m² irradiance intensity) with the test area facing inward. One cycle QUV consisted of 8-hour UV irradiation at 60° C. followed by 4-hour water spray at 50° C. After multiple cycles in the QUV equipment for 720 hours, all the panels were removed from the QUV equipment. These panels were dried at room temperature and final L₁*, a₁*, and b₁* values were measured. ΔE, indicating durability of the samples, was calculated as below formula:

ΔE=\sqrt{(L*₁−L*₀)²+(a*₁−a*₀)²+(b*₁−b*₀)²}

ΔE value being 6.0 or less indicates acceptable durability. The smaller ΔE value, the better durability.

### Example (Ex) 1

A monomer emulsion (ME) was prepared by mixing BA (89 g), MMA (157 g), PEM (0.84 g), MAA (2.57 g), A-19 (6.67 g, 19% active), A-102 (5.72 g, 32% active) and DI water (61.5 g) and emulsified with stirring. Then, DI water (150 g) and FEVE 4302 (220 g, 49% solids) were charged to a one-liter multi-neck flask fitted with mechanical stirring. The contents in the flask were heated to 30° C. under a nitrogen atmosphere. To the stirred flask, a solution of APS (0.26 g APS in 3 g DI water) was added to the flask. Then the ME (163 g) was added gradually over 35 min at a feed rate of 4.66 g per min. Flask temperature was maintained at 30° C. Then, FeSO₄·7H₂O (2.48 g, 0.2% active) and ethylenediamine tetraacetic acid (EDTA) (4.36 g, 1% active) were added to the flask. A solution of t-BHP (0.3 g t-BHP (70% active) in 9 g water) and a solution of FF-6 (0.18 g FF-6 in 9 g water) were fed into the flask over 4 min with agitation. The temperature of flask started to increase after 2 min, and a temperature increase of 30° C. was observed over 10 min. The flask was held at this temperature for 15 min. And then the remaining ME was added gradually over 35 min, followed by adding a solution of t-BHP (0.4 g t-BHP (70% active) in 9 g water) and a solution of FF-6 (0.25 g FF-6 in 9 g water) over 4 min with agitation. The temperature of the flask started to increase after 2 min, and a temperature increase of 20° C. was observed over 10 min. The flask was held at this temperature for 15 min. Thereafter, a solution of t-BHP (1.13 g t-BHP (70% active) in 22 g water) and a solution of FF-6 (0.68 g FF-6 in 22 g water) were fed into the flask over 30 min. The contents in the flask were cooled to room temperature. AMP-95 was added into the flask to adjust the pH value to 9.0, and then EN-130 (101 g, 40% solids) was added over 15 min. The obtained dispersion was diluted using DI water to 44% solids content.

### Ex 2

Ex 2 was prepared as Ex 1, except the monomers, FEVE 4302 and EN-130 used are as follows:

A monomer emulsion (ME) was prepared by mixing BA (89 g), MMA (157 g), PEM (0.84 g), MAA (2.57 g), A-19 (19% active, 6.67 g), A-102 (5.72 g, 32% active) and DI water (61.5 g) and emulsified with stirring. Then DI water (150 g) and FEVE 4302 (171 g, 49% solids) were charged to a one-liter multi-neck flask fitted with mechanical stirring. After polymerization process, EN-130 (94.4 g, 40% solids) was added over 15 min.

### Ex 3

Ex 3 was prepared as Ex 1, except the monomers, FEVE 4302 and EN-130 used are as follows:

A monomer emulsion (ME) was prepared by mixing BA (89 g), MMA (157 g), PEM (0.84 g), MAA (2.57 g), A-19 (6.67 g, 19% active), A-102 (5.72 g, 32% active) and DI water (61.5 g) and emulsified with stirring. Then DI water (150 g) and FEVE 4302 (512 g, 49% solids) were charged to a 2-liter multi-neck flask fitted with mechanical stirring. After polymerization process, EN-130 (142 g, 40% solids) was added over 15 min.

### Ex 4

Ex 4 was prepared as Ex 1, except the monomers, FEVE 4302 and EN-130 used are as follows:

A monomer emulsion (ME) was prepared by mixing BA (89 g), MMA (157 g), PEM (0.84 g), MAA (2.57 g), A-19 (6.67 g, 19% active), A-102 (5.72 g, 32% active) and DI water (61.5 g) and emulsified with stirring. Then DI water (150 g) and FEVE 4302 (1194 g, 49% solids) were charged to a 2-liter multi-neck flask fitted with mechanical stirring. After polymerization process, EN-130 (236.9 g, 40% solids) was added over 15 min.

### Ex 5

Ex 5 was prepared as Ex 1, except the monomers, FEVE 4302 and EN-130 used are as follows:

A monomer emulsion (ME) was prepared by mixing BA (89 g), MMA (154.4 g), PEM (2.51 g), MAA (2.57 g), A-19 (19% active, 6.67 g), A-102 (32% active, 5.72 g) and DI water (61.5 g) and emulsified with stirring. Then DI water (150 g) and FEVE 4302 (220 g, 49% solids) were charged to a one-liter multi-neck flask fitted with mechanical stirring. After polymerization process, APM-95 was added into the flask to adjust the pH value to 9.0, and then EN-130 (101 g, 40% solids) was added over 15 min.

### Ex 6

Ex 6 was prepared as Ex 1, except the monomer emulsion was prepared as follows:

A monomer emulsion (ME) was prepared by mixing BA (127 g), MMA (121 g), PEM (0.84 g), MAA (2.57 g), A-19 (19% active, 6.67 g), A-102 (5.72 g, 32% active) and DI water (61.5 g) and emulsified with stirring.

### Ex 7

Ex 7 was prepared as Ex 1, except the monomers, FEVE 4302 and EN-130 used are as follows:

A monomer emulsion (ME) was prepared by mixing BA (89 g), MMA (157 g), PEM (0.84 g), MAA (2.57 g), A-19 (6.67 g, 19% active), A-102 (5.72 g, 32% active) and DI water (61.5 g) and emulsified with stirring. Then DI water (150 g) and FEVE 4302 (220 g, 49% solids). After polymerization process, APM-95 was added to the flask to adjust the pH value to 9.0. Then EN-130 (48.2 g, 40% solids) was added over 15 min.

### Comparative Example (Comp) Ex 1

Comp Ex 1 was prepared as Ex 1 except no EN-130 silica sol was added. The final dispersion was diluted using DI water to 44% solids content.

### Comp Ex 2

A monomer emulsion (ME) was prepared by mixing BA (290 g), MMA (510 g), PEM (2.72 g), MAA (8.37 g), A-19 (21.6 g, 19% active), A-102 (18.6 g, 31% active) and DI water (200 g) and emulsified with stirring. Then, DI water (515 g) and A-102 (2.13 g, 31% active) were charged to a five-liter multi-neck flask fitted with mechanical stirring. The contents in the flask were heated to 91° C. under a nitrogen atmosphere. To the stirred flask, a solution of Na₂CO₃ (2.96 g Na₂CO₃ in 25 g DI water), the ME (30 g) with rinse DI water (15 g), and a solution of APS (0.85 g APS in 10 g DI water) were added to the flask. The remaining ME and another solution of APS (0.85 g APS in 35 g water) were added gradually over 90 min. Flask temperature was maintained at 88° C. DI water (20 g) was used to rinse the monomer emulsion feed line to the flask. Thereafter, FeSO₄·7H₂O (0.005 g) and EDTA (0.01 g) in water (5 g), t-BHP (0.59 g, 70% active) in water (11 g), and isoascorbic acid (IAA) (0.33 g) in water (11 g) were fed into the flask over 30 min with agitation. The contents in the flask were cooled to room temperature. AMP-95 was added into the flask to adjust the pH value to 9.0. Then EN-130 (233 g, 40% solids) was added over 15 min. The obtained dispersion was diluted using DI water to 44% solids content.

### Comp Ex 3

FEVE 4302 (717 g, 49% solids) was added into 2-liter flask with agitation, and then EN-130 (99.58 g) was added into the flask for 15 min. The obtained dispersion was adjusted to the pH value to 9.0 with AMP-95 and diluted using DI water to 44% solids content.

### Comp Ex 4

A monomer emulsion (ME) was prepared by mixing BA (290 g), MMA (510 g), PEM (2.72 g), MAA (8.37 g), A-19 (21.6 g, 19% active), A-102 (18.6 g, 31% active) and DI water (200 g) and emulsified with stirring. Then, DI water (515 g) and A-102 (2.13 g, 31% active) were charged to a five-liter multi-neck flask fitted with mechanical stirring. The contents in the flask were heated to 91° C. under a nitrogen atmosphere. To the stirred flask, a solution of Na₂CO₃ (2.96 g Na₂CO₃ in 25 g DI water), the ME (30 g) with rinse DI water (15 g), and a solution of APS (0.85 g APS in 10 g DI water) were added to the flask. The remaining ME and another solution of APS (0.85 g APS in 35 g water) were added gradually over 90 min. Reactor temperature was maintained at 88° C. DI water (20 g) was used to rinse the monomer emulsion feed line to the flask. Thereafter, FeSO₄.7H₂O (0.005 g) and EDTA (0.01 g) in water (5 g), a solution of t-BHP (0.59 g t-BHP (70% active) in 11 g water), and a solution of IAA (0.33 g IAA in 11 g water) were fed into the flask over 30 min with agitation. The contents in the flask were cooled to room temperature. AMP-95 was added into the flask to adjust the pH value to 9.0. Then FEVE 4302 (717 g, 49% solids) and EN-130 (332 g, 40% solids) were added over 15 min. The obtained dispersion was diluted using DI water to 44% solids content.

### Comp Ex 5

Comp Ex 5 was prepared as Ex 1, except a monomer emulsion (ME) was prepared by mixing BA (89 g), MMA (157 g), MAA (3.86 g), A-19 (6.67 g, 19% active), A-102 (5.72 g, 32% active) and DI water (61.5 g) and emulsified with stirring, and the obtained dispersion was diluted using DI water to 44% solids content.

### Comp Ex 6

Comp Ex 6 was prepared as Ex 1, except FEVE 4302 and EN-130 used are as follows:

FEVE 4302 (128 g, 49% solids) was added into the reactor. After polymerization process, EN-130 (88.8 g) was added into the reactor over 15 min. The obtained dispersion was diluted using DI water to 44% solids content.

### Coating Compositions

The above obtained aqueous dispersions or compositions of Exs 1-7 and Comp Exs 1-6 were used as binders and further formulated to coating compositions, based on formulations given in Table 1. Firstly, all ingredients in the grind stage were added sequentially and mixed using a high speed disperser at 4,000 revolutions per min (rpm) for 30 min to get a well dispersed slurry. Then ingredients in the letdown stage were added sequentially into the slurry with stirring at 1,000 rpm for 30 min. Properties of the obtained coating compositions were evaluated according to the test methods described above and results are given in Table 2.

TABLE 1
Coating Compositions

| | Dosage |
|---|---|
| Raw Material | Weight (g) |
| Grind | |
| Water | 55 |
| Natrosol 250HBR | 0.75 |
| AMP-95 | 0.25 |
| Propylene Glycol | 7.5 |
| OROTAN 731A | 4.536 |
| TRITON CF-10 | 0.5 |
| Tego Foamex 825 | 0.25 |
| Ti-Pure R-902 | 67.5 |
| Minex 4 | 15.25 |
| CC-700 | 59 |
| End Grind | 211 |
| Letdown | |
| DF-16 | 1.5 |
| Binder | 247 |
| ROPAQUE Ultra E | 12.5 |
| Tego Foamex 825 | 0.25 |
| Texanol | 21.9 |
| ACRYSOL RM-2020 NPR rheology modifier | 1 |
| ACRYSOL RM-8W rheology modifier | 0.45 |
| ROCIMA 363 biocide | 3.5 |
| Total | 499 |

As shown in Table 2, Coatings 1-7 comprising the aqueous polymer compositions of Exs 1-7 made by in-situ polymerization all demonstrated both good DPUR and durability properties. As compared to Ex 1, the aqueous composition of Comp Ex 4 (a blend of FEVE, an acrylic copolymer and colloidal silica) provided coatings with much poorer DUPR properties (Comp coating 4). The aqueous dispersion of Comp Ex 1 free of colloidal silica provided coatings with poor DPUR (Comp coating 1). The aqueous dispersions of Comp Exs 2 and 3 containing pure acrylic copolymer and pure FEVE copolymer, respectively, both provided coatings with poor DPUR and durability (as indicated by chalking or cracking of Comp coatings 2 and 3). Comp Ex 5 where the acrylic copolymer containing no structural units of PEM) and Comp Ex 6 comprising hybrid polymer particles containing 20% FEVE copolymer both provided coatings with poor durability as indicated by higher ΔE and film chalking (Comp coatings 5 and 6).

TABLE 2
Coating composition and DPUR and durability properties

| | Binder composition | | | Properties of coatings | |
|---|---|---|---|---|---|
| | | | Calculated Fox | Accelerated | |
| Coating | | | Tg of acrylic | DPUR | Durability, ΔE |
| Composition | Example | Polymer type | copolymer | test, ΔY | (720 hours) |
| Comp Coating 1 | Comp Ex 1 | Hybrid polymer | 27° C. | 15 | 1.9 |
| Comp Coating 2 | Comp Ex 2 | Pure acrylic copolymer | 27° C. | 13 | 11.9 (chalking) |
| Comp Coating 3 | Comp Ex 3 | Pure FEVE copolymer | / | 15 | cracking |
| Comp Coating 4 | Comp Ex 4 | Acrylic copolymer/ | 27° C. | 11 | 2.6 |
| | | FEVE copolymer | | | |
| | | admixture | | | |
| Comp Coating 5 | Comp Ex 5 | Hybrid polymer | 27° C. | 7 | 8.2 (chalking) |
| Comp Coating 6 | Comp Ex 6 | Hybrid polymer | 27° C. | 8 | 7.3 (chalking) |
| Coating 1 | Ex 1 | Hybrid polymer | 27° C. | 8 | 3.8 |
| Coating 2 | Ex 2 | Hybrid polymer | 27° C. | 8 | 5.6 |
| Coating 3 | Ex 3 | Hybrid polymer | 27° C. | 8 | 2.1 |
| Coating 5 | Ex 4 | Hybrid polymer | 27° C. | 8 | 1.5 |
| Coating 5 | Ex 5 | Hybrid polymer | 27° C. | 6 | 6.0 |
| Coating 6 | Ex 6 | Hybrid polymer | 5° C. | 9 | 2.0 |
| Coating 7 | Ex 7 | Hybrid polymer | 27° C. | 10 | 1.7 |

What is claimed is:

1. An aqueous composition comprising:
(a) an aqueous dispersion of hybrid polymer particles with a fluorine content of 5% or more, wherein the hybrid polymer particles comprise, based on the weight of the hybrid polymer particles,
(i) greater than 20% to 75% by weight of a first polymer component comprising a fluoroethylene vinyl ether copolymer, and
(ii) from 25% to less than 80% by weight of a second polymer component, wherein the second polymer component is an acrylic copolymer comprising, based on the weight of the acrylic copolymer, from 0.15% to 1.2% by weight of structural units of a phosphorus-containing acid monomer, a salt thereof, or mixtures thereof; and structural units of a monoethylenically unsaturated nonionic monomer; and
(b) from 5% to 30% by dry weight of colloidal silica, based on the total weight of the hybrid polymer particles and dry weight of the colloidal silica.

2. The aqueous composition of claim 1, wherein the hybrid polymer particles comprise an interpenetrating polymer network of the first polymer component and the second polymer component.

3. The aqueous composition of claim 1 wherein the acrylic copolymer has a glass transition temperature in the range of from 0 to 30° C.

4. The aqueous composition of claim 1 wherein the acrylic copolymer comprises, based on the weight of the acrylic copolymer, from 0.2% to 0.5% by weight of structural units of the phosphorus-containing acid monomer, the salt thereof, or mixtures thereof.

5. The aqueous composition of claim 1 wherein the acrylic copolymer further comprises, based on the weight of the acrylic copolymer, from 0.1% to 5% by weight of structural units of an additional monoethylenically unsaturated ionic monomer selected from a carboxylic acid monomer, a sulfonic acid monomer, a sulfate monomer; salts thereof; or mixtures thereof.

6. The aqueous composition of claim 1 wherein the fluoroethylene vinyl ether copolymer is an alternating copolymer, a random copolymer, or a block copolymer.

7. The aqueous composition of claim 1 wherein the colloidal silica is an anionic colloidal silica.

8. The aqueous composition of claim 1 wherein the colloidal silica comprises silica particles with an average particle size of 5 to 100 nanometers.

9. The aqueous composition of claim 1 further comprising a pigment, an extender, or mixtures thereof, wherein the aqueous composition has a pigment volume concentration of from 8% to 50%.

10. A process for preparing the aqueous composition of claim 1 comprising: admixing the aqueous dispersion of hybrid polymer particles with the colloidal silica.

11. The process of claim 10, wherein the aqueous dispersion of hybrid polymer particles is prepared by polymerization of an acrylic monomer mixture in the presence of the fluoroethylene vinyl ether copolymer, wherein the acrylic monomer mixture comprises, based on the weight of the acrylic monomer mixture, from 0.15% to 1.2% by weight of a phosphorous-containing acid monomer, a salt thereof, or mixtures thereof; and a monoethylenically unsaturated nonionic monomer.
